(19) United States
(12) Patent Application Publication
(10) Pub. No.: US 2022/0221976 A1
(43) Pub. Date: Jul. 14, 2022

(54) MOVEMENT OF VIRTUAL OBJECTS WITH RESPECT TO VIRTUAL VERTICAL SURFACES

(71) Applicant: A9.com, Inc., Palo Alto, CA (US)

(72) Inventors: Mukul Agarwal, San Francisco, CA (US); Yu Lou, Palo Alto, CA (US); Anandram Sundar, Santa Clara, CA (US); Chun Kai Wang, Sunnyvale, CA (US); Jack Mousseau, Palo Alto, CA (US); Kevin May, Oakland, CA (US); Xing Zhang, Santa Clara, CA (US); Yadikaer Yasheng, Palo Alto, CA (US); Geng Yan, San Carlos, CA (US)

(21) Appl. No.: 17/148,366

(22) Filed: Jan. 13, 2021

(51) Int. Cl. G06F 3/0481; G06F 3/0486; G06F 3/0484

(52) U.S. Cl. CPC G06F 3/04815; G06F 3/04845; G06F 3/0486

(57) ABSTRACT

A virtual vertical surface in a three-dimensional space that represents a physical room may be detected. Responsive to a first user input gesture, movement of a virtual object within the three-dimensional space may be displayed. The movement may be to a first location in which a portion of the virtual object intersects a portion of the virtual vertical surface. A virtual vertical surface designator may be displayed corresponding to the virtual vertical surface based at least in part on the portion of the virtual object intersecting the portion of the virtual vertical surface. Upon determining that a second user input gesture meets or exceeds a movement threshold, movement of the three-dimensional object from the first location to a second location within the three-dimensional space may be displayed. The second location may appear beyond the virtual vertical surface.

### BACKGROUND

Virtual and augmented reality technology has expanded in recent years. This expansion has led to the adoption of this technology in various fields of endeavor. For example, as part of shopping for an item, a user can now use this technology to view a virtual representation of the item within a physical space or a three-dimensional representation of the physical space. This may enable the user to determine how the item might look and fit within the physical space prior to purchasing the item.

### BRIEF DESCRIPTION OF THE DRAWINGS

Various examples in accordance with the present disclosure will be described with reference to the drawings, in which:

FIG. 1 illustrates a block diagram and a flowchart showing an example process for detecting movement of virtual objects with respect to virtual vertical surfaces, according to at least one example;

FIG. 2 illustrates an example computing device for implementing techniques relating to detecting movement of virtual objects with respect to virtual vertical surfaces, according to at least one example;

FIG. 3 illustrates an example of a three-dimensional space in which techniques relating to detecting movement of virtual objects with respect to virtual vertical surfaces may be implemented, according to at least one example;

FIG. 4 illustrates an example view of graphical user interface in which techniques relating to detecting movement of virtual objects with respect to virtual vertical surfaces may be implemented, according to at least one example;

FIG. 5 illustrates an example view of graphical user interface in which techniques relating to detecting movement of virtual objects with respect to virtual vertical surfaces may be implemented, according to at least one example;

FIG. 6 illustrates an example view of graphical user interface in which techniques relating to detecting movement of virtual objects with respect to virtual vertical surfaces may be implemented, according to at least one example;

FIG. 7 illustrates an example view of graphical user interface in which techniques relating to detecting movement of virtual objects with respect to virtual vertical surfaces may be implemented, according to at least one example;

FIG. 8 illustrates an example view of graphical user interface in which techniques relating to detecting movement of virtual objects with respect to virtual vertical surfaces may be implemented, according to at least one example;

FIG. 9 illustrates an example view of graphical user interface in which techniques relating to detecting movement of virtual objects with respect to virtual vertical surfaces may be implemented, according to at least one example;

FIG. 10 illustrates an example flow diagram depicting a process for implementing techniques relating to detecting movement of virtual objects with respect to virtual vertical surfaces, according to at least one example;

FIG. 11 illustrates an example flow diagram depicting a process for implementing techniques relating to detecting movement of virtual objects with respect to virtual vertical surfaces, according to at least one example;

FIG. 12 illustrates an example schematic architecture or system for implementing techniques relating to detecting movement of virtual objects with respect to virtual vertical surfaces, according to at least one example; and

FIG. 13 illustrates an environment in which various examples can be implemented.

### DETAILED DESCRIPTION

In the following description, various examples will be described. For purposes of explanation, specific configurations and details are set forth in order to provide a thorough understanding of the examples. However, it will also be apparent to one skilled in the art that the examples may be practiced without the specific details. Furthermore, well-known features may be omitted or simplified in order not to obscure the example being described.

Examples described herein are generally directed to selectively displaying features of a virtual space such as a room in a manner that helps users place and align virtual objects within the virtual space. For example, a computer application may enable a user to “view” a piece of furniture and other objects within an image of a physical space such as the user's living room before purchasing the piece of furniture. The computer application may generate a virtual representation of the physical space in the form of a three-dimensional model that takes into account walls, floor, ceilings, and/or objects already within the room. The computer application may also enable the user to align the object with the virtual representations of walls within the physical space.

In a particular example in a virtual reality embodiment, a virtual representation of the piece of furniture may be displayed within a three-dimensional representation of a user's living room. The application may enable the user to move and rotate the item to see how the piece of furniture will fit and look in the living room. As furniture items are often aligned with walls of a physical room, the techniques described herein inform the user when the virtual object has “contacted” a virtual wall (e.g., a virtual vertical surface). In this case, contact between the virtual object and the virtual wall may include a portion of a three-dimensional model of the object intersecting with a portion of the virtual wall. Once the intersection between the object and the virtual wall has been detected, the application may generate a virtual wall designator (e.g., a virtual representation of the virtual wall) that cues the user that the object has contacted the virtual wall. If the user continues to drag the virtual object toward the virtual wall, movement of the virtual object will be interrupted for a short period of time (e.g., a mouse pointer may continue to move towards the virtual wall, but the virtual object may stay at the same location). This interruption again informs the user that the object has moved as close to the wall as is possible. If the user, however, continues to drag the virtual object towards the wall, after the mouse pointer has traveled a threshold distance (e.g., some predefined number of pixels), the virtual object may be moved instantly to a location that appears behind the virtual wall. This again informs the user that the virtual object has moved too far and is no longer aligned with the virtual wall. To return the virtual object to the virtual room, the virtual object may be dragged back across the virtual wall.

The techniques described herein may provide one or more technical improvements to the user device and/or a service provider computer that implements aspects of the techniques. For example, accuracy of modeling physical spaces by the service provider computer may improve as the service provider computer generates more models. Centralizing the model generation, may free up resources on the user device to perform other less resource-intensive operations. Additionally, when the user device has sufficient computing resources to generate the models and track interaction with the models, bandwidth may be preserved because data transmission between the user device and the service provider computer is minimized. Use of the described user interface for interacting with three-dimensional models may enable more efficient and more accurate placement of objects as compared to conventional user interfaces that require more click-throughs, more precise cursor movements, and the like to align objects with walls.

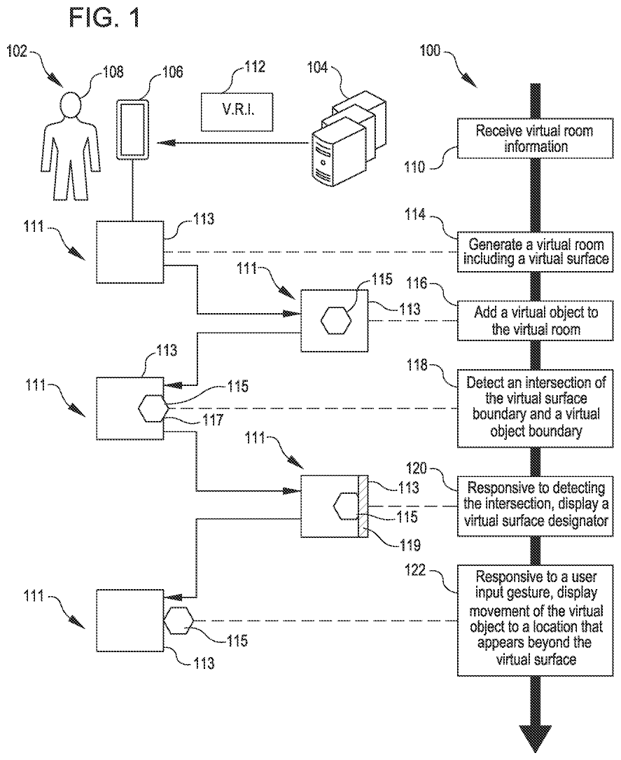

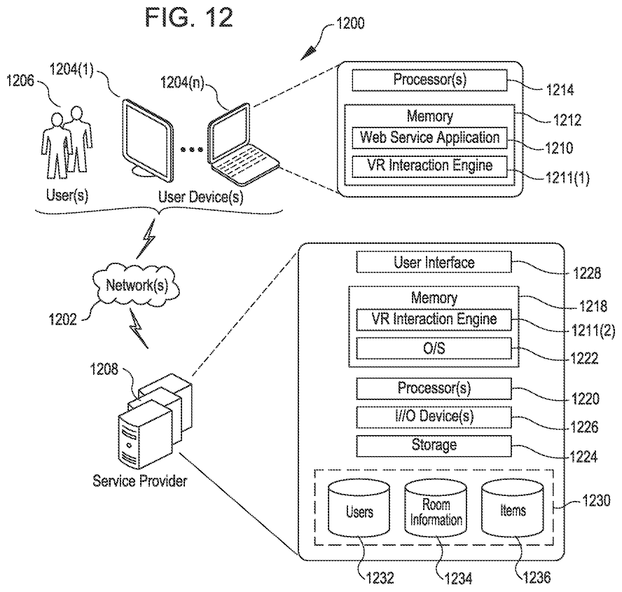

Turning now to the figures, FIG. 1 illustrates a block diagram 102 and a flowchart showing a process 100 for detecting movement of virtual objects with respect to virtual vertical surfaces, according to at least one example. The diagram 102 depicts graphical elements in a two-dimensional view from above. It should be understood, however, that the graphical elements may be presented in any suitable perspective in more than two-dimensions. The diagram 102 includes a service provider 104 and a user device operated by a user 108. As described in further detail with respect to FIG. 12, the service provider 104 is any suitable combination of computing devices such as one or more server computers, which may include virtual resources, capable of performing the functions described with respect to the service provider. Generally, the service provider 104 is configured to generate virtual room information, which may be based on images or other data uploaded to the service provider from a user device 106.

The user device 106 is any suitable electronic user device capable of communicating with the service provider 104 and other electronic devices over a network such as the Internet, a cellular network, or any other suitable network. In some examples, the user device 106 may be a smartphone, mobile phone, smart watch, tablet, laptop, desktop computer, or other user device on which specialized applications can operate. The user device 106 may be uniquely associated with the user 108 (e.g., via an account used to log in to the user device 106).

FIGS. 1, 10, and 11 illustrate example flow diagrams showing processes 100, 1000, and 1100, according to at least a few examples. These processes, and any other processes described herein, are illustrated as logical flow diagrams, each operation of which represents a sequence of operations that can be implemented in hardware, computer instructions, or a combination thereof. In the context of computer instructions, the operations may represent computer-executable instructions stored on one or more non-transitory computer-readable storage media that, when executed by one or more processors, perform the recited operations. Generally, computer-executable instructions include routines, programs, objects, components, data structures and the like that perform particular functions or implement particular data types. The order in which the operations are described is not intended to be construed as a limitation, and any number of the described operations can be combined in any order and/or in parallel to implement the processes.

Additionally, some, any, or all of the processes described herein may be performed under the control of one or more computer systems configured with specific executable instructions and may be implemented as code (e.g., executable instructions, one or more computer programs, or one or more applications) executing collectively on one or more processors, by hardware, or combinations thereof. As noted above, the code may be stored on a non-transitory computer-readable storage medium, for example, in the form of a computer program including a plurality of instructions executable by one or more processors.

The process 100 begins at 110 by the user device 106 receiving virtual room information 112 from the service provider 104. The virtual room information 112 may include a three-dimensional model of a physical space such as a room. The three-dimensional model may have been generated by the service provider 104 using one or more feature detection algorithms (e.g., heuristic or machine learning) to identify features such as walls, floor, ceilings, and other features present in one or more scans (e.g., image, laser, etc.) of the physical space. In some examples, the user device 106 provides the scans to the service provider 104 at an earlier time. For example, an application on the user device 106 may be used to direct the user to capture the scans of the room to ensure that a sufficient amount of information is present for generating the three-dimensional model. In some examples, the user device 106 may include a Light Detection and Ranging (LIDAR) system. The LIDAR system may be used by the user device 106 to capture data that is used by the service provider 104 to generate the three-dimensional model, or may be used by the user device 106 to generate the three-dimensional model (e.g., without sending the data to the service provider 104). The service provider 104 may obtain the data for generating the model in any other suitable manner.

In any event, the virtual room information 112 may be used by the user device 106, at 114, to generate a virtual room 111 including a virtual vertical surface 113. This may include using the virtual room information 112 to present the virtual room 111 including the virtual vertical surface 113 on a display of the user device 106. The virtual vertical surface 113 may represent and be associated with a physical wall in the physical room. In some examples, the user device 106 also uses the virtual room information 112 to generate more walls, floor(s), ceiling(s), and other objects represented by the virtual room information 112 to define the virtual room 111. These other objects may also be presented on the display of the user device 106. In some examples, these objects along with the virtual vertical surface 113 may represent virtual constraint elements of the room (e.g., boundaries of the room).

At 116, the user device 106 adds a virtual object 115 to the virtual room 111 generated at 114. For example, a graphical user interface presented on the user device 106 may enable the user 108 to select the virtual object 115 such as a piece of furniture from a set of objects and place the virtual object 115 into the virtual room 111. In some examples, the dimensions of the virtual object 115 may be automatically scaled to match the dimensions of the virtual room 111. This may enable the user 108 to see how a physical object represented by the virtual object 115 might look in the physical room. The graphical user interface may be configured to provide tools for the user 108 to manipulate the virtual object 115 within the virtual room 111 (e.g., for moving, rotating, scaling, and performing other manipulations of the virtual object 115). As part of this movement, the user device 106 may, at 118, detect an intersection 117 of the virtual vertical surface 113 and the virtual object 115. The intersection 117 may be detected with a portion of the three-dimensional model that represents the virtual object 115 intersects a portion of the three-dimensional model that represents the virtual vertical surface 113. This may occur when the user 108 moves the virtual object 115 towards and against the virtual vertical surface 113.

At 120, the user device 106, responsive to detecting the intersection 117 detected at 118, displays a virtual vertical surface designator 119. The virtual vertical surface designator 119 may be a graphical element that approximates the location of the virtual vertical surface 113. Prior to the virtual vertical surface designator 119 being triggered for presentation, the virtual vertical surface 113 and others may not be displayed. Rather, an image of the actual physical space may be presented. However, once the user 108 has moved the virtual object 115 into contact with the virtual vertical surface 113, the virtual vertical surface designator 119 may be displayed to inform the user of the contact. For example, the user 108 may select the virtual object 115 and drag it towards the virtual vertical surface 113, which, as detected at 118, will cause the virtual vertical surface designator 119 to be revealed at 120.

At 122, the user device 106, responsive to a user input gesture, displays movement of the virtual object 115 to a location that appears beyond the virtual vertical surface 113. For example, the user input gesture may include the user 108 continuing to drag the virtual object 115 towards the virtual vertical surface 113. The user 108 may use an input element such as a pointer to select the virtual object 115 and drag the virtual object 115 towards the wall 113. When the virtual object 115 intersects the virtual vertical surface 113 (e.g., at 118), the virtual object 113 may cease moving even though the input element may continue to move towards the wall 113 for some threshold distance. Once the input element has traveled the threshold distance, the virtual object 115 may programmatically snap to the new location of the input element at a distance that is greater than or equal to the threshold distance. This may cause the virtual object 115 to appear beyond the virtual vertical surface 113 (e.g., on the other side of the virtual vertical surface). This cueing may be helpful to inform users when they have dragged the virtual object 115 too far. The threshold distance also provides some room for error when the user 108 wants to align the virtual object 115 with the virtual vertical surface 113, e.g., any dragging movement between when the virtual vertical surface designator 119 is presented and within the threshold distance, the virtual object 115 will stay in contact with the virtual vertical surface 113.

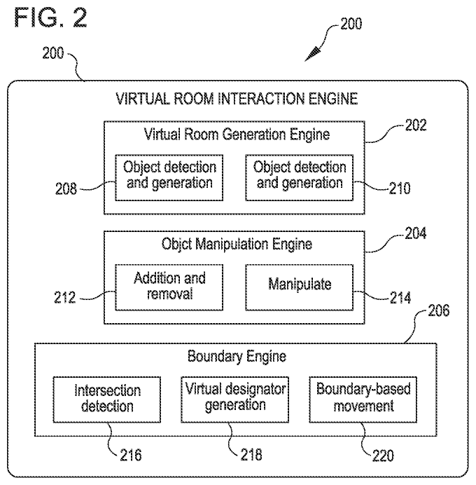

FIG. 2 illustrates an example virtual room interaction engine 200 for implementing techniques relating to detecting movement of virtual objects with respect to virtual vertical surfaces, according to at least one example. Generally, the virtual room interaction engine 200 may be implemented as a processor-executed engine, and may include a plurality of processor-executable engines such as a virtual room generation engine 202, an object manipulation engine 204, and boundary engine 206. In some examples, the engines may be implemented in hardware such as using one or more dedicated processors.

Beginning first with the virtual room generation engine 202, this engine may include functionality for object detection and generation 208 and for boundary detection and generation 210. Object detection and generation 208 may include processing input previously captured images or real-time images of a physical room or any other data representing the physical room to identify objects present in the physical room and to generate virtual representations of the identified objects. For example, the virtual room generation engine 202 may detect an existing object in a room and generate a three-dimensional model of the existing object. In some examples, the virtual room generation engine 202 may be configured to identify objects by comparing them to a library of objects. In this example, generating the model may also be performed or may be accessed from the library of objects. To identify the objects, the virtual room generation engine 202 may utilize any suitable object detection algorithm, which may include machine learning models trained to identify objects. The three-dimensional model of the virtual object may be a cuboidal model, a mesh model, or any other suitable model.

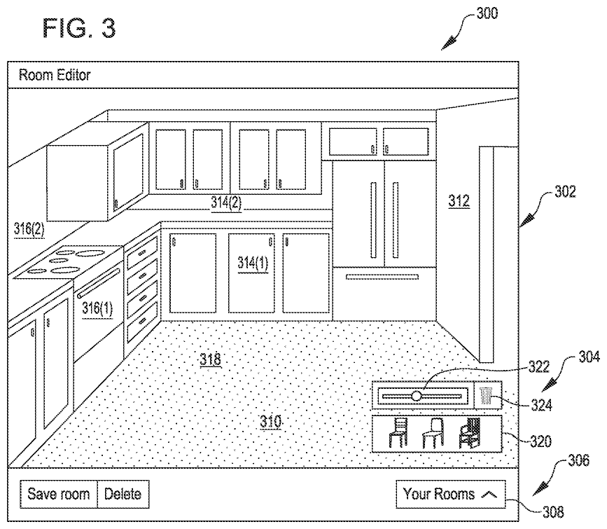

Boundary detection and generation 210 may include using the images described previously to identify boundary features of the physical room and generate virtual representations of the identified boundary features. This may include identifying walls and other vertical planes such as a set of cabinets, large piece of furniture, etc. (e.g., generally vertical planes) and ceilings, floor, and other generally flat objects (e.g., generally horizontal planes) and their relationships one with another. In some examples, the physical room may include planes that are not vertical or horizontal such as those oriented at any suitable angle with respect to others. These may be represented by the virtual representations. As illustrated in FIG. 3, the physical room may also include multiple walls at various depths (e.g., one at a first depth of a set of cabinets and one at a second depth of a backsplash on a far wall).

In some examples, the virtual representations may approximate the physical walls of the physical room. It will be appreciated that the accuracy of these approximations may vary depending on the input data, the time allocated to generate the boundary features, computing resources, and the like. The techniques described herein may account for this fact by providing the threshold distance required before an object will move beyond a wall.

The object manipulation engine 204 may include functionality for addition and removal 212 of virtual objects from within a three-dimensional space. As illustrated in FIG. 3, this may include providing tools and functionality within a graphical user interface for a user to add virtual objects to a virtual space and delete virtual objects from the three-dimensional space. The object manipulation engine 204 may also include functionality for manipulation 214 of virtual objects within the three-dimensional space. As illustrated in FIG. 3, this may include providing tools and functionality within the graphical user interface for the user to move, rotate, and align the virtual objects.

The boundary engine 206 may include functionality for detection of intersections 216, generation of virtual designators 218, and boundary-based movement 220. Detection of intersections 216 may include functionality to detect when a portion of a model of a virtual object intersects a model of a virtual vertical surface or other feature. Generation of virtual designators 218 may include functionality to generate and present virtual designators as described herein. Boundary-based movement 220 may include tracking movement of an input element and moving virtual objects to a location that appears to be beyond corresponding virtual vertical surfaces when certain conditions are met.

FIG. 3 illustrates an example view of a graphical user interface 300 in which techniques relating to detecting movement of virtual objects with respect to virtual vertical surfaces may be implemented, according to at least one example. The graphical user interface 300 may be presented on any suitable user device 106. The graphical user interface 300 includes a view area 302, tools 304, and a menu 306.

In the view area 302 is presented an image of a physical space such as a kitchen. Using a room selector 308 in the menu 306, a user may toggle between different saved rooms (e.g., images and models of other rooms associated with a particular user account/profile). The graphical user interface 300 may enable a user to design actual rooms without having to be in the room, e.g., by using a virtual reality technology rather than augmented reality, which could require the user to view the virtual objects within a room using live image data from a camera that is viewing the room. Using the menu 306, the user may also save the room and delete the room.

The physical space in the view area 302 includes a floor 310, a right wall 312, a first back wall 314(1) and a second back wall 314(2), and a first left wall 316(1) and a second left wall 316(2). The wall 113 is an examples of the walls in FIG. 3. In some examples, only a single back wall 314 and a single left wall 316 are provided, e.g., the first back wall 314(1) and the first left wall 316(1). The view area 302 also includes a virtual floor designator 318 that depicts an area of the floor 310. The virtual floor designator 318 is depicted as a pattern of repeating dots. In some examples, each of the walls 312, 314, 316, floor 310, and ceiling may be detected from one or more images of the physical space. Once detected, digital information that represents these features may be generated and shared with the user device at which the graphical user interface 300 is presented. In this manner, the graphical user interface 300 may be used to present an image of the physical space and selectively present virtual boundaries corresponding to features of the physical space.

The pattern of the virtual floor designator 318 informs the user as to where virtual objects may be placed. The tools 304 may include a tray of virtual objects 320 that may be added to the three-dimensional space shown in the view area 302. The tray of virtual objects 320 includes a set of chairs. The graphical user interface 300 may enable the user to search for other virtual objects that may be presented in the tray of virtual objects 320, in other trays, or in any other suitable manner. The tools 304 also include a rotational selector 322 and a trash icon 324. The rotational selector 322 may be used to rotate an object once in the three-dimensional space and the trash icon 324 may be selected to delete an object, e.g., remove it from the three-dimensional space. The rotational selector 322 is provided separate from the virtual objects presented in the three-dimensional space.

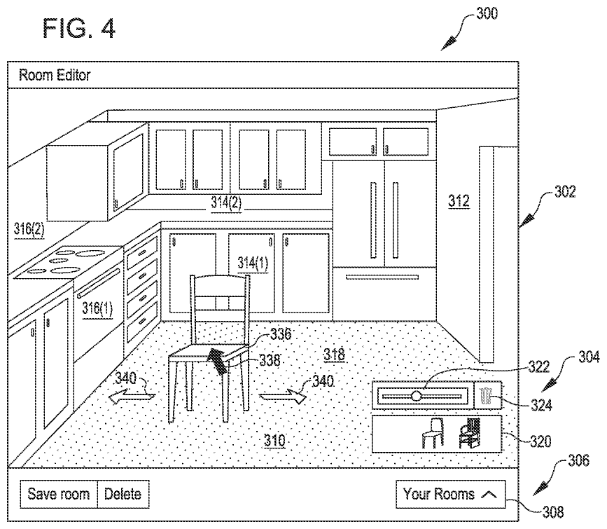

FIG. 4 illustrates an example view of the graphical user interface 300 in which techniques relating to detecting movement of virtual objects with respect to virtual vertical surfaces may be implemented, according to at least one example. In particular, in the view of the graphical user interface 300 illustrated in FIG. 4, a virtual object 336 (e.g., the virtual object 115) has been added to the three-dimensional space and placed on the floor 310. For example, a user may have selected the virtual object 336 (a chair) from the tray of virtual objects 320 using an input element 338 (e.g., depicted as a mouse pointer) and dragged the virtual object 336 in the room and onto the floor 310. Properties of the virtual floor designator 318 may have changed to alert the user that the virtual object 336 may be placed on the floor 310. As illustrated in FIG. 4, the input element 338 remains on the virtual object 336 indicating that the user has continued to select the virtual object. Movement indicators 340 are generated and presented adjacent to the virtual object 336. The movement indicators 340 may indicate directions in which the virtual object 336 may be moved. To rotate the virtual object, the user may use the rotational selector 322. In some examples, while dragging the virtual object 336, positioning of the virtual object 336 may be determined by a raycast from a location of the input element 338

In some examples, the input element 338 may be transparent and/or may not be presented at the graphical user interface 300. For example, when the user device includes a touchscreen, the input element may correspond to the user's finger or stylus, which may not be depicted at a mouse pointer.

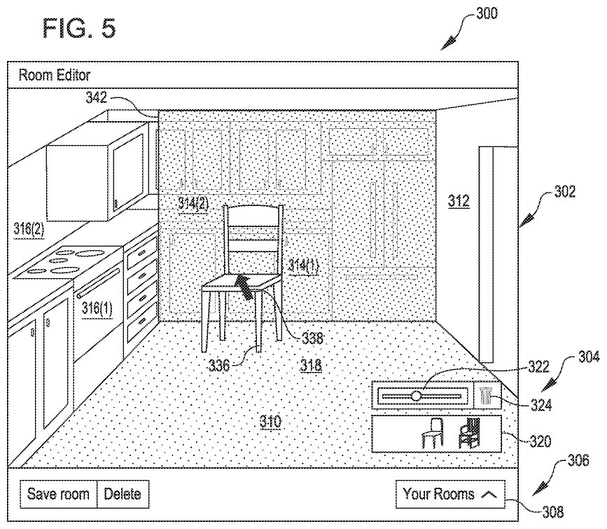

FIG. 5 illustrates an example view of the graphical user interface 300 in which techniques relating to detecting movement of virtual objects with respect to virtual vertical surfaces may be implemented, according to at least one example. In particular, in the view of the graphical user interface 300 illustrated in FIG. 5, the virtual object 336 has been moved back towards the first back wall 314(1). For example, the user may have selected the virtual object using the input element 338 and dragged the virtual object 336 at least until a portion of the virtual object 336 (e.g., a leg or back of the chair) intersects with a virtual representation of the first back wall 314(1). When this intersection is detected, the graphical user interface may be updated to display a virtual vertical surface designator 342 (e.g., the virtual vertical surface designator 119) that represents the first back wall 314(1), or at least where the system has estimated the back wall 314 of three-dimensional space to be. The virtual vertical surface designator 342 may be presented in any suitable manner and have any suitable properties. For example, the virtual vertical surface designator 342 may take the form of a curtain that extends from ceiling to floor 310 and from left wall 312 to right wall 316. In some examples, the virtual vertical surface designator 342 may have different levels of transparency, ranging from opaque to transparent. In some examples, the virtual vertical surface designator 342 may be presented as a repeating pattern (e.g., dots, lines, shapes, etc.), a single color, multiple colors, and the like. In some examples, as the user attempts to “push” the virtual object 336 further towards the wall 314, properties of the virtual vertical surface designator 342 may change. For example, a color or brightness or other indicator of intensity may increase as the virtual object 336 is pushed further towards the wall 314. The virtual vertical surface designator 342 may have a fade-in animation from 0 to 35% opacity over 0.0 to 0.2 seconds. The virtual vertical surface designator 342 may fade in when the user moves the virtual object 336 into contact with the virtual vertical surface and/or when the virtual object 336 is selected at a later time after being brought into contact with the virtual vertical surface.

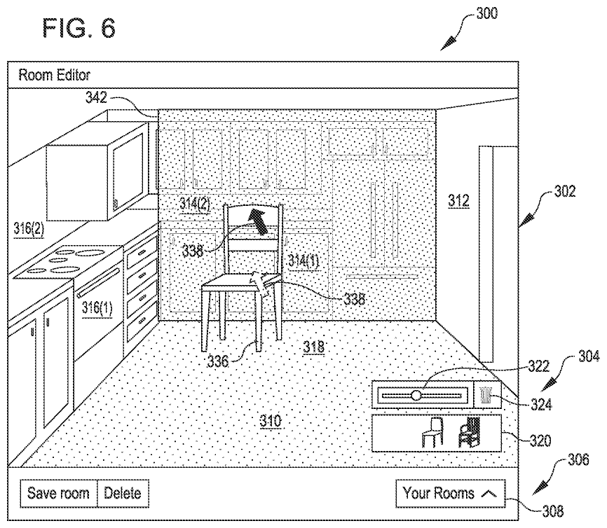

As illustrated in FIG. 6, as the user continues to push the virtual object 336 into the wall 314, movement of the virtual object 336 will be obstructed by the virtual vertical surface corresponding to the wall 314. During this time, the input element 338 will continue to move in the direction towards the wall 314. This is illustrated by the input element 338 moving from the position in FIG. 5 (shown with diagonal fill lines) on the chair seat to the current position in FIG. 6 on the chair back. In some examples, the distance between the two positions may be measured in terms of pixels or other suitable measurement unit and compared to a threshold. The threshold, which may be referred to herein as a movement threshold, may be defined by how far the input element 338 must move in the direction of a virtual vertical surface before the virtual object 336 will jump to the backside of the virtual vertical surface. In some examples, the threshold distance may be between 40 and 80 pixels for a desktop application and 40 or fewer pixels for a mobile application. In some examples, the distance is greater than 80 pixels or less than 40 pixels. The distance may be measured in any direction of travel of the input element 338 (e.g., up, down, right, left, diagonal, or any combination of the foregoing). The value of the distance may be selected to balance two competing interests. A first interest is that if the distance is too small, it may be difficult for users to place virtual objects against the wall. The second interest is that if the distance is too large, the user may not figure out that they cannot go beyond the wall. Thus, the distance may be selected to give users an opportunity to quickly align virtual objects with a wall without requiring absolute precision in placement.

In some examples, a hysteresis of 40 pixels is defined along the normal of the virtual vertical surface projected in 2D space. When the input element has moved 40 pixels, the virtual vertical surface designator 342 may have an opacity of zero and the virtual object 336 may do an immediate movement in the same direction as movement of the input element to a position it would have been if the wall was not there. In some examples, the movement threshold may be measured within a camera space. For example, the location of the virtual object 336 may be represented by a distance of the virtual object 336 from a floor projection coordinate system of the camera that captured the images of the physical room to a central portion of the virtual object 336. In this example, calculating the 40 pixel threshold is performed by projecting the top down layout view onto the screen of a user device (e.g., each wall with normal (x, y, z) in camera space may become a line perpendicular (x, −z)), and projecting the drag displacement of the input element onto (x, −z) and determine if that value is greater than −40. The hysteresis would begin again if the virtual object 336 is returned to within the virtual walls.

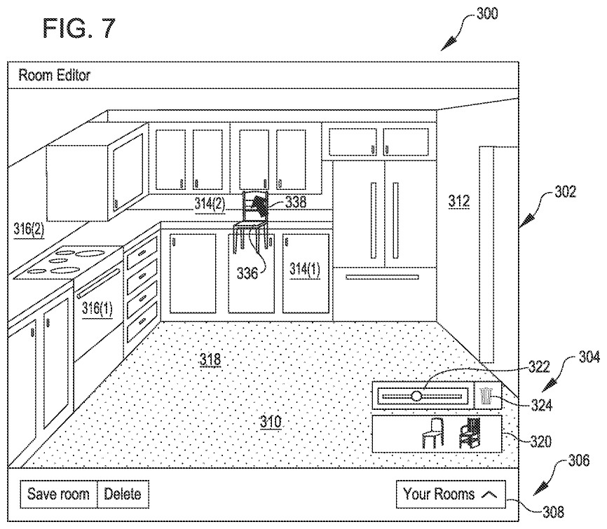

FIG. 7 illustrates an example view of the graphical user interface 300 in which techniques relating to detecting movement of virtual objects with respect to virtual vertical surfaces may be implemented, according to at least one example. In particular, in the view of the graphical user interface 300 illustrated in FIG. 7, the virtual object 336 has been moved to a location that appears beyond or behind the first back wall 314(1). As can be seen, the input element 338 has remained in the same position with respect to the virtual object 336 as in FIG. 6. Thus, as the user continued to move the input element 338 in a direction towards the first back wall 314, the input element travels a distance that meets or exceeds the threshold. Once the threshold has been reached, the system automatically moves the virtual object 336 to the position illustrated in FIG. 7. At this same time, the virtual vertical surface designator 342 may no longer be displayed. This may inform the user that the virtual object 336 has moved beyond the back wall 314. In some examples, the virtual vertical surface designator 342 may continue to be displayed in the same form or with adjusted properties. In some examples, when the system detects multiple walls in parallel planes such as the first back wall 314(1) and the second back wall 314(2), the virtual object 336 may pass through a virtual representation of the first wall and then a second virtual vertical surface designator for the second back wall 314(2) may light up when the virtual object 336 intersects the second back wall 314(2). The same may be achieved when the virtual object 336 is moved to the left or to the right.

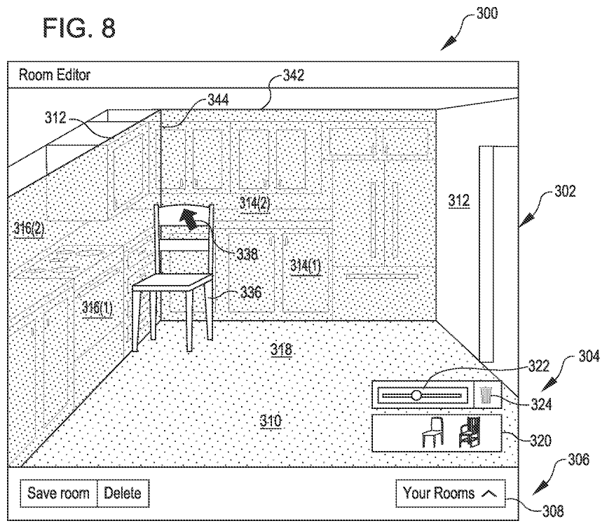

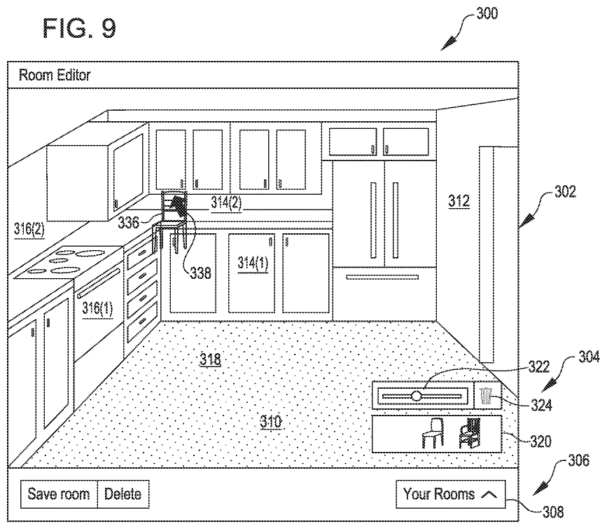

FIG. 8 illustrates an example view of the graphical user interface 300 in which techniques relating to detecting movement of virtual objects with respect to virtual vertical surfaces may be implemented, according to at least one example. In particular, in the view of the graphical user interface 300 illustrated in FIG. 8, the virtual object 336 has been moved to a corner location 344 of the first back wall 314(1) and the first left side wall 316(1). In this example, two virtual vertical surface designators 342 and 344 have been triggered for presentation. This is because the virtual object 336 has been moved to a location (e.g., the corner location 344) at which the virtual object 336 intersects both virtual vertical surfaces. If the user continues to move the virtual object 336 toward the corner location 344, the virtual object 336 will “pass through” a first of the walls first, then the second wall second, as described previously. If the user keeps the virtual object 336 aligned with one of the walls (e.g., the first left side wall 316(1) and continues to move the virtual object 336 towards the first back wall 314(1), the virtual object 336 will stay aligned with the first left side wall 316(1) and pass through the first back wall 314(1) first. For example, as illustrated in FIG. 9, the virtual object 336 has passed beyond the first back wall 314(1) and remains aligned with the first left side wall 316(1). This may be desirable because it gives the user more freedom to control the placement of the virtual object in circumstances when one of the walls (e.g., the first back wall 314(1)) is at an incorrect location.

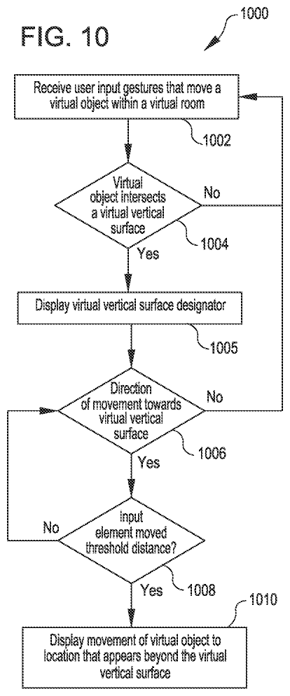

FIG. 10 illustrates an example flow diagram depicting a process for implementing techniques relating to detecting movement of virtual objects with respect to virtual vertical surfaces, according to at least one example. In particular, the process 1000 may relate to determining when to automatically move a virtual object to a location that appears beyond a virtual vertical surface. A virtual room interaction engine 200 (FIG. 2) of the user device 106 (FIG. 1) may perform the process 1000.

The process 1000 begins at block 1002 by the user device receiving user input gestures that move a virtual object within a virtual room. This may include the user selecting and dragging the virtual object or using any other suitable technique (e.g., using a keypad to select and move).

At block 1004, the process 1000 includes the user device determining whether the virtual object intersects a virtual vertical surface of the virtual room. As described herein, intersecting the virtual vertical surface may occur when any portion of the virtual object intersects any portion of the virtual vertical surface, when a predefined section of the virtual object intersects a predefined portion of the virtual vertical surface, and any combination of the foregoing. In some examples, intersecting the virtual vertical surface may include the virtual object contacting the virtual vertical surface. If the answer at block 1004 is NO, the process 1000 returns to block 1002. If the answer at block 1004 is YES, the process 1000 continues to block 1005. At block 1005, the process 1000 includes the user device displaying a virtual vertical surface designator. This may be responsive to the determination at 1004.

At block 1006, the process 1000 includes the user device determining whether the direction of movement of the virtual object is towards the virtual vertical surface. This may be performed using any suitable input element tracking technique. For example, a position of an input element used to select and drag the virtual object may be tracked to determine directionality of the movement of the virtual object. This computation may be based on the number of pixels the input element travels or based on a camera space coordinate system.

If the answer at block 1006 is NO, the process 1000 returns to block 1002. If the answer at block 1006 is YES, the process 1000 continues to block 1008. At block 1008, the process 1000 includes the user device determining whether the input element has moved a threshold distance. This may be performed by comparing the difference between a first pixel location of the input element when the virtual object first intersects the virtual vertical surface and a second pixel location of the input element as the input element moves toward the virtual vertical surface. Thus, the first pixel location may be relatively stable, but the second pixel location will change as the input element is moved. When the second pixel location is located the threshold distance away from the first pixel location and in a direction towards the virtual vertical surface (determined at 1006), the answer at 1008 will be YES. If not, the process 1000 will continue to determine whether the direction of movement is towards the virtual vertical surface. Again, if the answer at 1008 is YES, the process 1000 will continue to block 1010. At block 1010, the process 1000 includes the user device displaying movement of the virtual object to a location that appears beyond the virtual vertical surface. This may include automatically moving the virtual object that, to a user, may appear as a jump of the object to the new location. The new location may correspond to the second pixel location. In other words, the distance that the virtual objects move to get to the location that appears behind the virtual vertical surface may be about equal to the threshold distance.

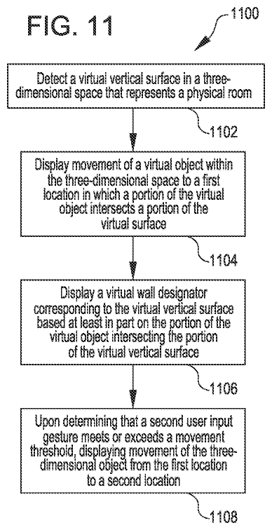

FIG. 11 illustrates an example flow diagram depicting a process for implementing techniques relating to detecting movement of virtual objects with respect to virtual vertical surfaces, according to at least one example. In particular, the process 1100 may relate to an overall process of determining when to present a virtual vertical surface designator and when to automatically move a virtual object based a movement threshold. A virtual room interaction engine 200 (FIG. 2) of the user device 106 (FIG. 1) may perform the process 1100.

The process 1100 begins at block 1102 by the user device detecting a virtual vertical surface in a three-dimensional space that represents a physical room. This may be based on virtual room information obtained from a remote server or generated on-device by the user device.

At block 1104, the process 1100 includes the user device displaying movement of a virtual object within the three-dimensional space to a first location in which a portion of the virtual object intersects a portion of the virtual vertical surface. In some examples, displaying the movement may be responsive to a first user input gesture.

In some examples, prior to the first user input gesture, the process 1100 may include the user device displaying rotation of the virtual object in the three-dimensional space using a rotational control element that is separate from the virtual object.

At block 1106, the process 1100 includes the user device displaying a virtual vertical surface designator corresponding to the virtual vertical surface based at least in part on the portion of the virtual object intersecting the portion of the virtual vertical surface. In some examples, properties of the virtual vertical surface designator may be changeable with respect to user input gestures or other measured values. For example, an opacity property or intensity property of the virtual vertical surface designator may change with respect to the second user input gesture. As the input element is moved towards the virtual wall, the virtual vertical surface designator may begin to fade (e.g., decrease in opacity) at least until the movement threshold is met. At this point, the virtual vertical surface designator may become completely transparent (e.g., disappear from the view). In some examples, the opacity may increase as the user input element is moved towards the vertical virtual surface at least until the virtual object passes through the virtual vertical surface and the virtual wall disappears. Other variations of fading or otherwise changing properties of the virtual vertical surface designator are also possible.

In some examples, the three-dimensional object may be represented by a bounding box. In a first example, displaying the virtual vertical surface designator corresponding to the virtual vertical surface may include detecting an intersection between any portion of the bounding box and any portion of the virtual vertical surface. In a second example, displaying the virtual vertical surface designator corresponding to the virtual vertical surface may include detecting an intersection between a predefined portion of the bounding box and any portion of the virtual vertical surface.

At block 1108, the process 1100 includes the user device, upon determining that a second user input gesture meets or exceeds a movement threshold, displaying movement of the three-dimensional object from the first location to a second location within the three-dimensional space. The second location may be at a location that appears beyond the virtual vertical surface. The movement threshold may be defined in terms of pixels (e.g., a pixel threshold) that define an integer number of pixels that an input element must travel before displaying movement of the virtual object from the first location to the second location. As described herein, this value may be different depending on the application, but a reasonable range may be between 40 and 80 pixels. The second user input gesture may include selecting the virtual object using the input element, and moving the input element towards the virtual vertical surface without moving the virtual object at least until the input element has traveled the integer number of pixels.

In some examples, the second user input gesture includes a selecting part and a dragging part. The selecting part may occur at a first pixel location with respect to the virtual object and the dragging part may begin at the first pixel location and end at a second pixel location with respect to the virtual object. In some examples, the selecting part may include using an input element to select the virtual object at a first pixel location with respect to the virtual object, and the dragging part may include moving the input element towards the virtual vertical surface to a second pixel location. In some examples, the virtual object may remain at the first location at least until a distance traveled by the input element between the first pixel location and the second pixel location meets or exceeds the movement threshold.

In some examples, the process 1100 may also include the user device receiving virtual room information associated with the physical room. The virtual room information may represent the three-dimensional space including the virtual vertical surface that represents a physical wall of the physical room and a virtual floor that represents a physical floor of the physical room.

In some examples, the process 1100 may also include the user device displaying an image of the physical room (e.g., on a display of the user device). The image may have been taken by the user device or obtained in some other manner. For example, the user device may have captured the image of the room (e.g., in a user's home) at an earlier time and shared the image with a remote server that uses the image to generate the virtual features of present in the physical room (e.g., walls, floor, ceiling, obstructions, etc.).

In some examples, the process 1100 may also include the user device ceasing displaying of the virtual vertical surface designator after the virtual object has moved to the second location. In some examples, displaying movement of the three-dimensional object from the first location

In some examples, the process 1100 may also include the user device, responsive to a third user input gesture, displaying movement of the virtual object from the second location that appears beyond the virtual vertical surface to a third location within the three-dimensional space that appears within the virtual vertical surface. This may include the user dragging the virtual object from behind the wall to a location back within the room.

FIG. 12 illustrates an example schematic architecture or system 1200 for implementing techniques relating to detecting movement of virtual objects with respect to the virtual vertical surface, according to at least one example. The architecture 1200 may include a service provider 1208 (e.g., the service provider 104) in communication with one or more user devices 1204(1)-1204(N) (hereinafter, “the user device 106”) via one or more networks 1202 (hereinafter, “the network 1202”). The user device 1204 may be operable by one or more users 1206 (e.g., the user 108) to interact with the service provider 1208. The network 1202 may include any one or a combination of many different types of networks, such as cable networks, the Internet, wireless networks, cellular networks, and other private and/or public networks. The user 1206 may be any suitable user including, for example, customers of a selling platform that are associated with the service provider 1208, or any other suitable user.

Turning now to the details of the user device 1204, the user device 1204 may be any suitable type of computing device such as, but not limited to, a digital camera, a wearable device, a tablet, a mobile phone, a smart phone, a personal digital assistant (PDA), a laptop computer, a desktop computer, a thin-client device, a tablet computer, a set-top box, or any other suitable device capable of communicating with the service provider 1208 via the network 1202 or any other suitable network. For example, the user device 1204(1) is illustrated as an example of a smart phone, while the user device 1204(N) is illustrated as an example of a laptop computer.

The user device 1204 may include a web service application 1210 within memory 1212 and a virtual room interaction engine 1211(1) (e.g., the virtual room interaction engine 200). Within the memory 1212 of the user device 1204 may be stored program instructions that are loadable and executable on processor(s) 1214, as well as data generated during the execution of these programs. Depending on the configuration and type of user device 1204, the memory 1212 may be volatile (such as random access memory (RAM)) and/or non-volatile (such as read-only memory (ROM), flash memory, etc.). The web service application 1210, stored in the memory 1212, may allow the user 1206 to interact with the service provider 1208 via the network 1202. In some examples, the virtual room interaction engine 200 may allow the user 1206 to interact with the service provider 1208.

Turning now to the details of the service provider 1208, the service provider 1208 may include one or more service provider computers, perhaps arranged in a cluster of servers or as a server farm, and may host web service applications. These servers may be configured to host a website (or combination of websites) viewable on the user device 1204 (e.g., via the web service application 1210). The user 1206 may access the website to view items that can be ordered from the service provider 1208 (or a selling platform such as an electronic marketplace associated with the service provider 1208 and hosted by the web server 124). These may be presentable to the user 1206 via the web service applications.

The service provider 1208 may include at least one memory 1218 and one or more processing units (or processor(s)) 1220. The processor 1220 may be implemented as appropriate in hardware, computer-executable instructions, software, firmware, or combinations thereof. Computer-executable instruction, software, or firmware implementations of the processor 1220 may include computer-executable or machine-executable instructions written in any suitable programming language to perform the various functions described. The memory 1218 may include more than one memory and may be distributed throughout the service provider 1208.

The memory 1218 may store program instructions that are loadable and executable on the processor(s) 1220, as well as data generated during the execution of these programs. Depending on the configuration and type of memory including the service provider 1208, the memory 1218 may be volatile (such as random access memory (RAM)) and/or non-volatile (such as read-only memory (ROM), flash memory, or other memory). The memory 1218 may include an operating system 1222 and one or more application programs, modules, or services for implementing the techniques described herein including at least a virtual room interaction engine 1211(2).

The service provider 1208 may also include additional storage 1224, which may be removable storage and/or non-removable storage including, but not limited to, magnetic storage, optical disks, and/or tape storage. The disk drives and their associated computer-readable media may provide non-volatile storage of computer-readable instructions, data structures, program modules, and other data for the computing devices. The additional storage 1224, both removable and non-removable, are examples of computer-readable storage media. For example, computer-readable storage media may include volatile or non-volatile, removable or non-removable media implemented in any suitable method or technology for storage of information such as computer-readable instructions, data structures, program modules, or other data. As used herein, modules, engines, and components may refer to programming modules executed by computing systems (e.g., processors) that are part of the service provider 1208, and/or the user device 1204.

The service provider 1208 may also include input/output (I/O) device(s) and/or ports 1226, such as for enabling connection with a keyboard, a mouse, a pen, a voice input device, a touch input device, a display, speakers, a printer, or other I/O device.

The service provider 1208 may also include a user interface 1228. The user interface 1228 may be utilized by an operator or one of the users 1206 to access portions of the service provider 1208. In some examples, the user interface 1228 may include a graphical user interface, web-based applications, programmatic interfaces such as application programming interfaces (APIs), or other user interface configurations. The service provider 1208 may also include a data store 1230. In some examples, the data store 1230 may include one or more data stores, databases, data structures, or the like for storing and/or retaining information associated with the service provider 1208. Thus, the data store 1230 may include databases, such as user information database 1232, a room information database 1234, and an item database 1236. The user information database 1232 may be used to store data about users (e.g., the users 1206) of the system 1200. This may include preferences, purchase history, viewing history, demographic information, and the like. The room information database 1234 may include information about physical rooms and corresponding virtual room information. For example, the user 1206 may request the user device 1204 or the service provider 1208 to generate a virtual room based on one or more images of a physical room (e.g., living room, kitchen, bedroom, bathroom, garage, etc.), and, once generated, the information may be stored by the service provider 1208 in the room information database 1234. As described herein, the user device 1204 may generate the virtual room with little or no communications with the service provider 1208. The item database 1236 may include information about items that may be purchased using the platforms described herein and corresponding virtual information. For example, each item may be uniquely identified by a serial number and have a corresponding three-dimensional model associated therewith. This information may be used to populate the tray of virtual objects 320.

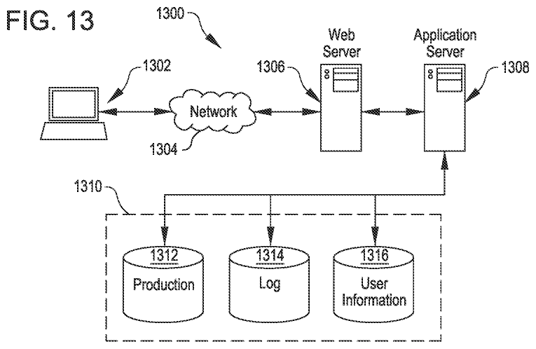

FIG. 13 illustrates aspects of an example environment 1300 for implementing aspects in accordance with various examples. As will be appreciated, although a Web-based environment is used for purposes of explanation, different environments may be used, as appropriate, to implement various examples. The environment includes an electronic client device 1302, which can include any appropriate device operable to send and receive requests, messages, or information over an appropriate network 1304 and convey information back to a user of the device. Examples of such client devices include personal computers, cell phones, handheld messaging devices, laptop computers, set-top boxes, personal data assistants, electronic book readers, and the like. The network can include any appropriate network, including an intranet, the Internet, a cellular network, a local area network, or any other such network or combination thereof. Components used for such a system can depend at least in part upon the type of network and/or environment selected. Protocols and components for communicating via such a network are well known and will not be discussed herein in detail. Communication over the network can be enabled by wired or wireless connections and combinations thereof. In this example, the network includes the Internet, as the environment includes a Web server 1306 for receiving requests and serving content in response thereto, although for other networks an alternative device serving a similar purpose could be used as would be apparent to one of ordinary skill in the art.

The illustrative environment includes at least one application server 1308 and a data store 1310. It should be understood that there can be several application servers, layers, or other elements, processes, or components, which may be chained or otherwise configured, which can interact to perform tasks such as obtaining data from an appropriate data store. As used herein the term “data store” refers to any device or combination of devices capable of storing, accessing, and retrieving data, which may include any combination and number of data servers, databases, data storage devices, and data storage media, in any standard, distributed, or clustered environment. The application server can include any appropriate hardware and software for integrating with the data store as needed to execute aspects of one or more applications for the client device, handling a majority of the data access and business logic for an application. The application server provides access control services in cooperation with the data store and is able to generate content such as text, graphics, audio, and/or video to be transferred to the user, which may be served to the user by the Web server in the form of HyperText Markup Language (“HTML”), Extensible Markup Language (“XML”), or another appropriate structured language in this example. The handling of all requests and responses, as well as the delivery of content between the client device 1302 and the application server 1308, can be handled by the Web server. It should be understood that the Web and application servers are not required and are merely example components, as structured code discussed herein can be executed on any appropriate device or host machine as discussed elsewhere herein.

The data store 1310 can include several separate data tables, databases or other data storage mechanisms and media for storing data relating to a particular aspect. For example, the data store illustrated includes mechanisms for storing production data 1312 and user information 1316, which can be used to serve content for the production side. The data store also is shown to include a mechanism for storing log data 1314, which can be used for reporting, analysis, or other such purposes. It should be understood that there can be many other aspects that may need to be stored in the data store, such as for page image information and to access right information, which can be stored in any of the above listed mechanisms as appropriate or in additional mechanisms in the data store 1310. The data store 1310 is operable, through logic associated therewith, to receive instructions from the application server 1308 and obtain, update or otherwise process data in response thereto. In one example, a user might submit a search request for a certain type of item. In this case, the data store might access the user information to verify the identity of the user and can access the catalog detail information to obtain information about items of that type. The information then can be returned to the user, such as in a results listing on a Web page that the user is able to view via a browser on the user device 1302. Information for a particular item of interest can be viewed in a dedicated page or window of the browser.

Each server typically will include an operating system that provides executable program instructions for the general administration and operation of that server and typically will include a computer-readable storage medium (e.g., a hard disk, random access memory, read only memory, etc.) storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one example is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 13. Thus, the depiction of the system 1300 in FIG. 13 should be taken as being illustrative in nature and not limiting to the scope of the disclosure.

The various examples further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and other devices capable of communicating via a network.

Most examples utilize at least one network that would be familiar to those skilled in the art for supporting communications using any of a variety of commercially available protocols, such as Transmission Control Protocol/Internet Protocol (“TCP/IP”), Open System Interconnection (“OSI”), File Transfer Protocol (“FTP”), Universal Plug and Play (“UpnP”), Network File System (“NFS”), Common Internet File System (“CIFS”), and AppleTalk. The network can be, for example, a local area network, a wide-area network, a virtual private network, the Internet, an intranet, an extranet, a public switched telephone network, an infrared network, a wireless network, and any combination thereof.

In examples utilizing a Web server, the Web server can run any of a variety of server or mid-tier applications, including Hypertext Transfer Protocol (“HTTP”) servers, FTP servers, Common Gateway Interface (“CGP”) servers, data servers, Java servers, and business application servers. The server(s) also may be capable of executing programs or scripts in response to requests from user devices, such as by executing one or more Web applications that may be implemented as one or more scripts or programs written in any programming language, such as Java®, C, C#, or C++, or any scripting language, such as Perl, Python, or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of examples, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (“CPU”), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired)), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate examples may have numerous variations from that described above. For example, customized hardware might also be used and/or particular elements might be implemented in hardware, software (including portable software, such as applets), or both. Further, connection to other computing devices such as network input/output devices may be employed.

Storage media, computer readable media for containing code, or portions of code can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (“EEPROM”), flash memory or other memory technology, Compact Disc Read-Only Memory (“CD-ROM”), digital versatile disk (DVD), or other optical storage, magnetic cassettes, magnetic tape, magnetic disk storage, or other magnetic storage devices, or any other medium which can be used to store the desired information and which can be accessed by a system device. Based on the disclosure and teachings provided herein, a person of ordinary skill in the art will appreciate other ways and/or methods to implement the various examples.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A computer-implemented method, comprising:
receiving virtual room information associated with a physical room, the virtual room information representing a three-dimensional space comprising a virtual vertical surface that represents a physical wall of the physical room and a virtual horizontal surface that represents a physical floor of the physical room;
displaying an image of the physical room, features of the image associated with the virtual room information;
responsive to a first user input gesture, displaying movement of a virtual object within the three-dimensional space to a first location in which a first portion of the virtual object intersects a portion of the virtual vertical surface;
displaying a virtual vertical surface designator corresponding to the virtual vertical surface based at least in part on the portion of the virtual object intersecting the portion of the virtual vertical surface; and
responsive to a second user input gesture, displaying movement of the virtual object from the first location to a second location in which at least the first portion of the virtual object appears beyond the virtual vertical surface at the second location, the second user input gesture being defined by a pixel movement threshold.

2. The computer-implemented method of claim 1, further comprising ceasing displaying of the virtual vertical surface designator after the virtual object has moved to the second location.

3. The computer-implemented method of claim 1, wherein displaying the virtual designator comprises adjusting opacity of the virtual vertical surface designator based at least in part on the second user input gesture.

4. The computer-implemented method of claim 1, wherein the pixel movement threshold defines an integer number of pixels that an input element that has selected the virtual object must travel before displaying movement of the virtual object from the first location to the second location.

5. The computer-implemented method of claim 4, wherein the second user input gesture comprises, while the virtual object is selected by the input element, moving the input element towards the virtual vertical surface without corresponding movement of the virtual object at least until the input element has traveled the integer number of pixels.

6. One or more computer-readable media comprising computer-executable instructions that, when executed by one or more processors, cause a user device to perform operations comprising:
detecting a virtual vertical surface in a three-dimensional space that represents a physical room, the virtual vertical surface corresponding to a physical vertical surface of the physical room;
responsive to a first user input gesture, displaying movement of a virtual object within the three-dimensional space to a first location in which a portion of the virtual object intersects a portion of the virtual vertical surface;
displaying a virtual vertical surface designator corresponding to the virtual vertical surface based at least in part on the portion of the virtual object intersecting the portion of the virtual vertical surface; and
upon determining that a second user input gesture meets or exceeds a movement threshold, displaying movement of the virtual object from the first location to a second location within the three-dimensional space, at least the portion of the virtual object appearing beyond the virtual vertical surface at the second location.

7. The one or more computer-readable media of claim 6, wherein the second user input gesture comprises, while the virtual object is selected, dragging the virtual object towards the virtual vertical surface.

8. The one or more computer-readable media of claim 7, wherein the second user input gesture begins at a first pixel location with respect to the virtual object and ends at a second pixel location with respect to the virtual object.

9. The one or more computer-readable media of claim 7, wherein an input element is used to select the virtual object at a first pixel location with respect to the virtual object, and dragging the virtual object comprises moving the input element towards the virtual vertical surface to a second pixel location.

10. The one or more computer-readable media of claim 9, wherein the virtual object remains at the first location at least until a distance traveled by the input element between the first pixel location and the second pixel location meets or exceeds the movement threshold.

11. The one or more computer-readable media of claim 6, wherein the one or more computer-readable media comprise additional computer-executable instructions that, when executed by the one or more processors, further cause the user device to perform operations comprising ceasing displaying of the virtual vertical surface designator after the virtual object has been moved to the second location.

12. The one or more computer-readable media of claim 6, wherein displaying movement of the virtual object from the first location to the second location occurs programmatically.

13. The one or more computer-readable media of claim 6, wherein the one or more computer-readable media comprise additional computer-executable instructions that, when executed by the one or more processors, further cause the user device to perform operations comprising, responsive to a third user input gesture, displaying movement of the virtual object from the second location that appears beyond the virtual vertical surface to a third location within the three-dimensional space that appears within the virtual vertical surface.

14. The one or more computer-readable media of claim 6, wherein the virtual object is represented by a three-dimensional model, and wherein displaying the virtual vertical surface designator corresponding to the virtual vertical surface comprises detecting an intersection between any portion of the three-dimensional model and any portion of the virtual vertical surface.

15. The one or more computer-readable media of claim 6, wherein the three-dimensional model comprises a mesh model or a bounding box model.

16. The one or more computer-readable media of claim 6, wherein the one or more computer-readable media comprise additional computer-executable instructions that, when executed by the one or more processors, further cause the user device to perform operations comprising, prior to the first user input gesture, displaying rotation of the virtual object in the three-dimensional space using a rotational control element that is separate from the virtual object.

17. The one or more computer-readable media of claim 6, wherein the one or more computer-readable media comprise additional computer-executable instructions that, when executed by the one or more processors, further cause the user device to perform operations comprising receiving, from a remote server, virtual room information that represents the three-dimensional space of the physical room.

18. A user device, comprising:
a display;
an input device;
a memory configured to store computer-executable instructions; and
a processor configured to access the memory and execute the computer-executable instructions to at least:
present, at the display, an image of a physical room;
generate a plurality of virtual constraint elements of a virtual room corresponding to the physical room based at least in part on virtual room information;
responsive to a select and drag gesture received at the input device and using an input element, display movement of a virtual object in a first direction at least until a portion of the virtual object intersects a portion of a first virtual constraint element of the plurality of virtual constraint elements;
present, at the display, a virtual constraint designator corresponding to the virtual constraint element based at least in part on the portion of the virtual object intersecting the portion of the virtual constraint element; and
responsive to a new select and drag gesture or a continuation of the select and drag gesture received at the input device and using the input element:
display movement of the input element in the first direction for a first distance without displaying movement of the virtual object from the first location; and
display movement of the virtual object from the first location to the second location when the first distance meets or exceeds a movement threshold.

19. The user device of claim 18, further comprising an image capture device, and wherein the processor is further configured to access the memory and execute additional computer-executable instructions to:
capture one or more images of the physical room; and
generate the virtual room information based at least in part on the one or more images.

20. The user device of claim 18, wherein the movement threshold is between 40 and 80 pixels measured at the display device.
